(19) United States
(12) Patent Application Publication
(10) Pub. No.: US 2015/0012331 A1
(43) Pub. Date: Jan. 8, 2015

(54) Computer-Implemented Intelligence Tool

(71) Applicant: 1st Call Consulting, Pte Ltd., Singapore (SG)

(72) Inventors: Keith Barrett Carter, Freeport, NY (US); Donald Wesley Carter, Freeport, NY (US)

(21) Appl. No.: 14/325,084

(22) Filed: Jul. 7, 2014

Related U.S. Application Data
(60) Provisional application No. 61/906,201, filed on Nov. 19, 2013.
(60) Provisional application No. 61/843,070, filed on Jul. 5, 2013.

(51) Int. Cl. G06Q 30/02; G06Q 50/00

(52) U.S. Cl. CPC G06Q 30/0201; G06Q 40/06; G06Q 50/01
USPC 705/7.29

(57) ABSTRACT

A method is directed to visually displaying aggregate social media sentiment data potentially impacting the value of an organization. The organization, which purchases or sells a good, is selected and multiple search terms related to the organization are sent to a sentiment analysis system. Multiple scores are received from the sentiment analysis system. Each score is associated with corresponding ones of the search terms and is indicative of a sentiment level on a first set of one or more social networking services about the corresponding search term. An aggregate sentiment value is calculated based on the scores. The aggregate sentiment value is indicative of an aggregate sentiment about the corresponding search term on the first set of one or more social networking services. A first visual representation is displayed to indicate a relationship between a monitored characteristic of the selected organization and the aggregate sentiment.

### REFERENCE TO RELATED APPLICATIONS

This application is related to and claims priority to U.S. Provisional Patent Application Ser. No. 61/906,201, filed Nov. 19, 2013, titled “Computer-Implemented Intelligence Tool,” and to U.S. Provisional Patent Application Ser. No. 61/843,070, filed Jul. 5, 2013, and titled “Computer-Implemented Intelligence Tool,” each of which is incorporated herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE PRESENT DISCLOSURE

An aspect of the present disclosure relates to a computer-implemented intelligence tool that allows a user to receive a comprehensive overview of his investment portfolio or portfolios, along with related information that the user may wish to use when making decisions regarding the composition of his portfolio or portfolios.

### BACKGROUND

Investors have to consider a number of factors when making investment decisions. Among other things, to determine whether they should buy, sell, or hold a given equity in their investment portfolios, investors need to consider factors such as: an organization's leadership structure, an organization's financials, recent news about the organization, the overall health of the economy, social media posts about the organization, analyst influence over the stock price of an organization, and/or the organization's competitors. Organizing data about these factors tends to be difficult, as the number of databases and other resources that an investor must access and/or analyze tends to be overwhelming for most investors, and it can be difficult to determine which resources are reliable. Furthermore, even if a user were able to access information about the relevant factors affecting the value of his investment portfolio, the user would still need to perform a comprehensive review and analysis of the data in order to determine how his portfolio was being affected. Because there is so much data to be analyzed and individual pieces of data are often not clearly related to each other, performing an accurate analysis is often difficult if not hopelessly insurmountable for investors. Aspects of the present disclosure address these and other shortcomings.

### SUMMARY

An aspect of the present disclosure takes the “pulse” of social media about a particular stock of interest or in an investor's portfolio by aggregating a sentiment on one or more social media networking services and then displaying a color indicating whether the overall sentiment is positive, neutral, or negative. Another aspect displays a risk triangle that characterizes different levels of risk present in an investor's portfolio, where the risk triangle is divided into sections commensurate with the percentage allocation of each risk level. Each section can also be colored to indicate the level of risk, such as red for a high risk, orange or yellow for a medium risk, and green for a low risk. A further aspect relates to aggregating recommendations made by analysts about a particular stock of interest, and quantifying how accurate those recommendations have been over time. The accuracy of a particular analyst's predictions about multiple stocks can be aggregated and quantified, or the accuracy of historical predictions about a particular stock can be aggregated and quantified.

Additional aspects of the present disclosure will be apparent to those of ordinary skill in the art in view of the detailed description of various aspects, which is made with reference to the drawings, a brief description of which is provided below.

### BRIEF DESCRIPTION OF THE DRAWINGS

FIG. 1A shows, in part, a functional block diagram of a system for implementing one or more aspects of the present disclosure;

FIG. 1B is a continuation of the functional block diagram of FIG. 1A;

FIG. 2A illustrates an example flowchart of an algorithm 200A for analyzing social media sentiment of one or more equities according to aspects of the present disclosure;

FIG. 2B illustrates another example flowchart of an algorithm 200B for analyzing social media sentiment of one or more equities according to aspects of the present disclosure;

FIG. 3 illustrates an example flowchart of an algorithm 300 for visually displaying data describing an analyst rating according to aspects of the present disclosure;

FIG. 4 illustrates an example flowchart of an algorithm 400 for visually displaying data describing a user's financial portfolio;

FIG. 5 illustrates an example flowchart of an algorithm 500 for presenting a user with a series of one or more recommendations describing equities (e.g., stocks, bonds, etc.) a user may want to buy, sell, or hold;

FIG. 6A-1 illustrates a screen shot of an example of a graphical user interface associated with one or more aspects of the present disclosure;

FIG. 6A-2 illustrates a screen shot of another example of a graphical user interface associated with one or more aspects of the present disclosure;

FIG. 6B-1 illustrates a screen shot of yet another example of a graphical user interface associated with one or more aspects of the present disclosure;

FIG. 6B-2 illustrates a screen shot of yet another example of a graphical user interface associated with one or more aspects of the present disclosure;

FIG. 6B-3 illustrates a screen shot of yet another example of a graphical user interface associated with one or more aspects of the present disclosure;

FIG. 6C illustrates a screen shot of yet another example of a graphical user interface associated with one or more aspects of the present disclosure; and

FIG. 6D illustrates a screen shot of yet another example of a graphical user interface associated with one or more aspects of the present disclosure.

### DETAILED DESCRIPTION

While the present disclosure can be embodied in many different forms, there is shown in the drawings and will be described various exemplary aspects of the present disclosure with the understanding that the present disclosure is to be considered as an exemplification of the principles thereof and is not intended to limit the broad aspect of the present disclosure to the illustrated aspects.

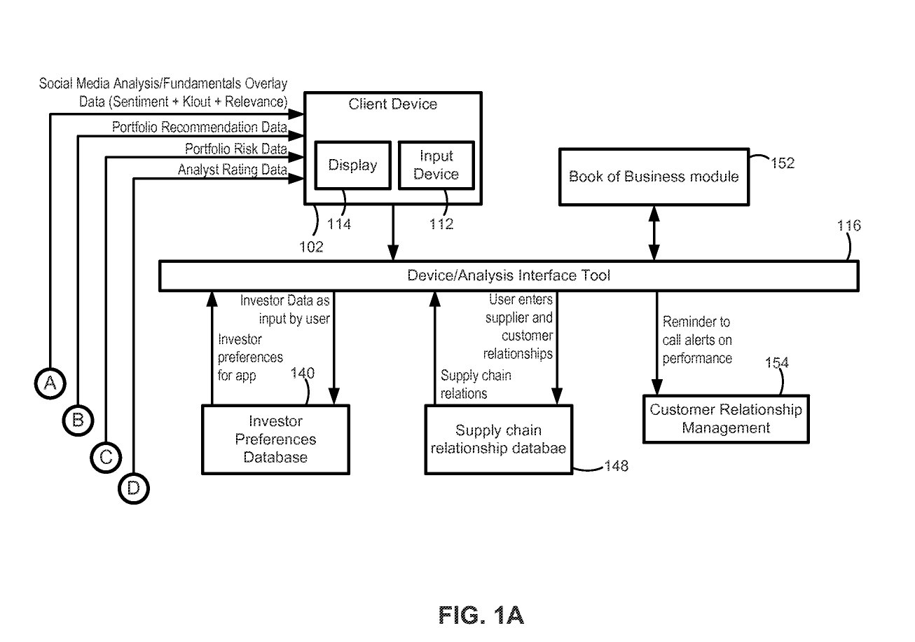

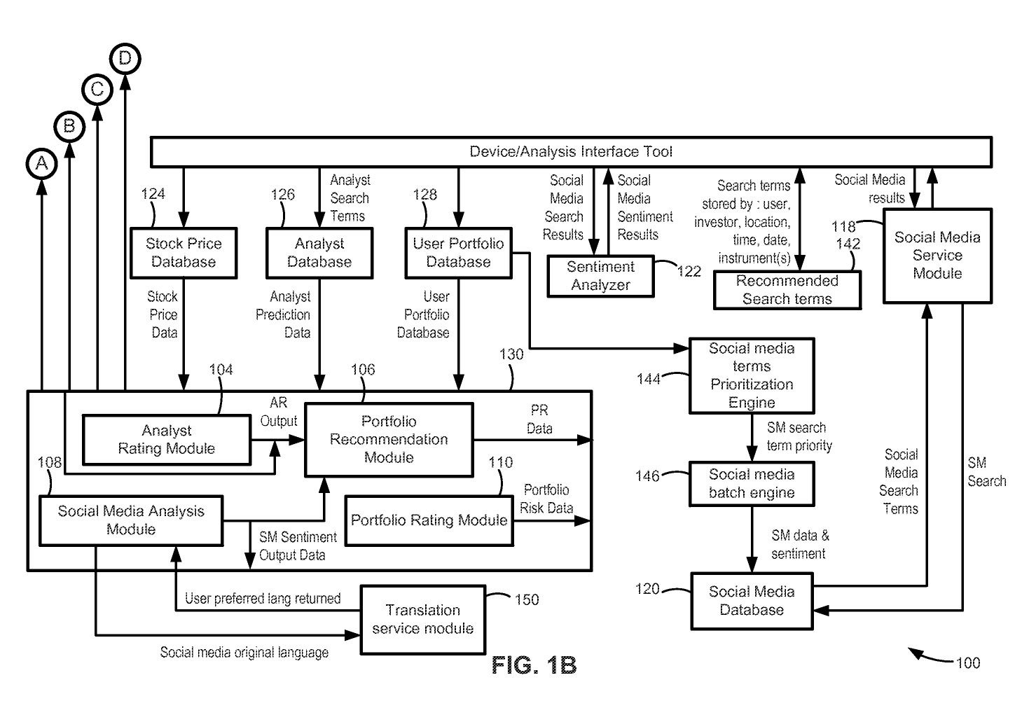

FIGS. 1A and 1B show a functional block diagram of various hardware and/or software or firmware components, modules, or features that are involved in some aspects of the present disclosure. A system 100 includes a client computing device 102, such as a smartphone, a laptop, a tablet computing device, a personal computer, or the like. An analyst rating module 104, a portfolio recommendation module 106, a social media analysis module 108, and a portfolio rating module 110 are computing modules hosted on an analysis server 130 remote from the client computing device 102. The analysis server 130 can be connected to the client computing device 102 through a public or private network, such as the Internet. The client computing device 102 includes one or more input devices 112 operatively coupled to a video display 114. Further, the client computing device 102 communicates with an analysis interface tool 116. The system 100 also includes a social media service module 118, a social media database 120, a sentiment analyzer 122, an equity price database 124, an analyst database 126, and a user portfolio database 128. The client computing device 102 includes one or more processor devices, a user interface device, such as the input device 112, which can include a touchscreen, a keyboard, a mouse, or any other suitable human-machine interface, and the video display device 114.

It should be emphasized that the exemplary architecture shown in FIGS. 1A and 1B is not intended to be limiting. For example, although only one client computing device 102 is shown in FIGS. 1A and 1B, it should be understood that many computing devices, each like the client computing device 102, can be communicatively and operatively linked to the analysis interface tool 116. Further, analysis interface tool 116 can support many client computing devices. Additionally, analysis interface tool 116 can be incorporated into the client computing device 102 or stored partially or entirely on another computing device. Further, in certain implementations, analyst rating module 104, portfolio recommendation module 106, social media analysis module 108, and portfolio rating module 110 can be stored on analysis server 130 or stored partially or entirely on another computing device.

As mentioned above, client computing device 102 communicates with an analysis interface tool 116. In certain implementations, the analysis interface tool 116 can be configured to communicate and interact with multiple data sources to perform consolidated data analysis and/or retrieve data of interest. In an implementation, and by way of example, the analysis interface tool 116 can be the QLIKVIEW business intelligence software tool available from QlikTech International AB. In other examples, the analysis interface tool 116 is the TABLEAU tool or other BI tools. The analysis interface tool 116 can be configured to send data, such as search terms received from the client computing device 102, other relevant data inquiries, or responses to user profile questions, to the equity price database 124, the analyst database 126, the user portfolio database 128, and/or the social media service module 118.

The social media service module 118 can be a software component configured to communicate with one or more third party social media services and databases via, for example, one or more application programming interfaces (APIs). Social media services include services such as, for example, Twitter, Facebook, MySpace, LinkedIn, etc., and some or all of the social media services can have associated databases storing profile and other relevant information about their respective users.

The system 100 can be used to generate a visual representation (e.g., a graph, chart, etc.) tracking social media sentiment regarding an organization of interest (e.g., a company that a user owns stock in). The system 100 can also be used to generate other visual representations of interest (e.g., financial portfolio overviews, analyst overviews, etc.). The visual representations may be displayed on the display 114 of the client computing device 102.

In an implementation analyzing the social media sentiment of an organization or organizations, a user can enter the name of one or more companies or other organizations that the user is interested in tracking using the input device 112. Based on the names of the one or more organizations, the client computing device 102 can use software stored locally on the client computing device 102 or remotely to generate relevant search terms related to the organization(s) of interest. These terms can include, for example, stock ticker names or symbols for an organization's stock, the official name of the organization, popular nicknames for the organization, names of the organization's board of trustees and other leaders or officers, or any other relevant search terms related to the organization. The names of the organizations and the generated search terms can be communicated to the analysis interface tool 116, which can communicate the terms to the social media service module 118.

As will described in more detail below, the social media service module 118 communicates with one or more selected social media services (e.g., Twitter, Facebook, LinkedIn, etc.) to retrieve relevant social media entries or posts (e.g., tweets, Facebook posts, LinkedIn updates, etc. about the organization of interest) based on the names of the organizations and the generated search terms. The entries are analyzed by one or more sentiment analyzers 122 to determine an overall sentiment (e.g., positive, negative, neutral, etc.) of each of the entries. After the sentiment analyzers 122 analyze individual entries, the social media analysis module 108 performs further analysis on the social media posts to generate an aggregate social media sentiment score. The social media analysis module 108 can also generate aggregate scores for each of the social media posts and combine and/or otherwise organize the scores such that a user is presented with a visual representation of the social media sentiment regarding an organization at a specific time or over a period of time on the display 114. In certain implementations, the visual representation can also include financial data (e.g., stock price, stock trading volume, etc.) regarding the organization or organizations of interest, allowing the user to see the correlation between social media sentiment and financial metrics of an organization.

The system 100 can also be used to generate a rating of one or more analysts and to display the generated results on the display 114 of the client computing device 102. More specifically, a user can enter the names of one or more analysts the user is interested in evaluating using the input device 112. The client computing device 102 can communicate the names to the analysis interface tool 116, which can interact with the equity price database 124, the analyst database 126, and/or the analysis rating module 104 to generate the analyst rating or ratings. The sources of information that the system 100 uses to generate an analyst rating includes a ticker name, such as from financial data aggregators and/or from subscribed financial data sources, a date, a closing price at the selected date, a recommendation by an analyst, the analyst's target price and time period for the target price to be achieved (e.g., $50 per share within the next three months), and an absolute return rank based on the analyst's coverage of a particular stock, such as from Bloomberg.

As will be described in more detail below, the analysis interface tool 116 can receive a variety of information about the selected analyst or analysts from the analyst database 126. This information may include, for example, the names of one or more organizations an analyst has followed and/or analyzed, the analyst's predictions regarding the value of the organization(s), and/or recommendations that the analyst has made to third parties about the organization(s). The analysis interface module 104 can also retrieve predictions an analyst has made about the value (e.g., as measured by the stock price) of an organization and/or recommendations to third parties about whether they should purchase, sell, or hold shares of the organization's stock. In addition to retrieving analyst information from the analyst database 126, the analysis interface module 104 can retrieve financial information (e.g., stock price data) about one or more of the organizations the analyst has followed and/or analyzed.

The retrieved data can be analyzed by the analyst rating module 104. More specifically, analyst rating module 104 can generate an aggregate analyst rating based on the accuracy of the analyst's predictions (e.g., regarding target stock prices) and/or advice (e.g., advising third parties to buy, hold, or sell one or more particular stocks or other financial instruments). Analysts who give accurate predictions and/or advice are rated more highly than analysts who provide less accurate predictions. After the analyst rating module 104 has generated one or more analyst ratings, the rating or ratings data can be communicated to the client computing device 102 so that they are presented in a visual representation on the display 114.

An average rating of analysts can be calculated by assigning a value or grade to each recommendation type. For example, a strong buy recommendation can be assigned a value of +2, a buy recommendation a value of +1, a hold recommendation a value of 0, a sell recommendation a value of −1, and a strong sell recommendation a value of −2. The average of all of the analysts' recommendation can be calculated to provide a consensus analyst rating, rounded to the closest value or grade. For example, if the average value of all of the recommendations made by the analysts is +1.35, then the average rating of the analysts can be returned as a “buy” and this average rating can be graphically presented on the display 114.

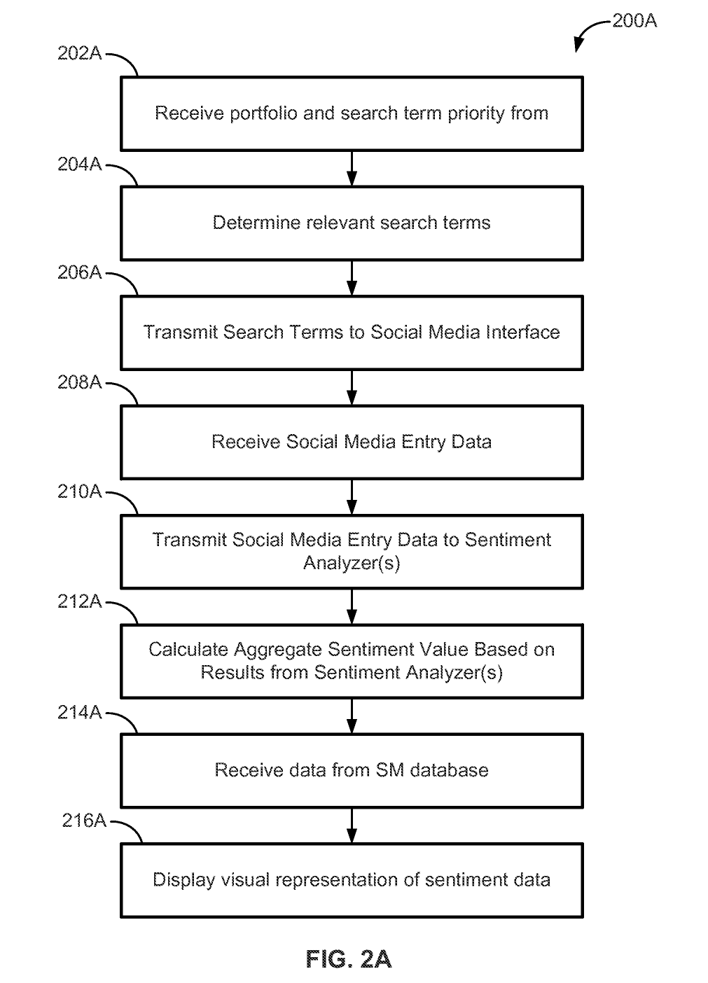

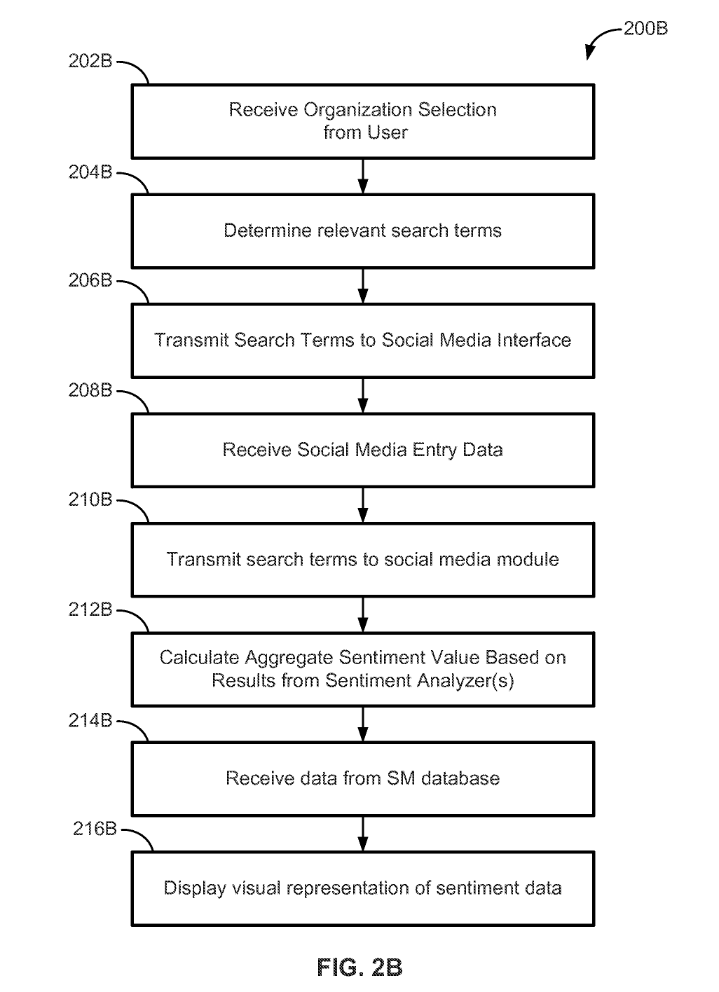

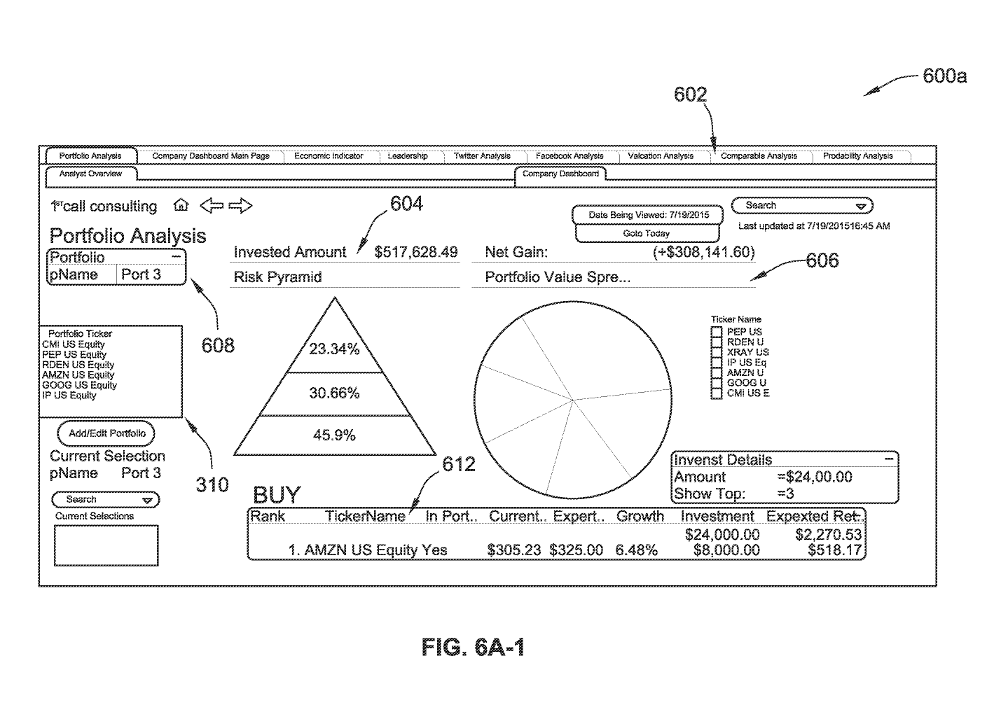

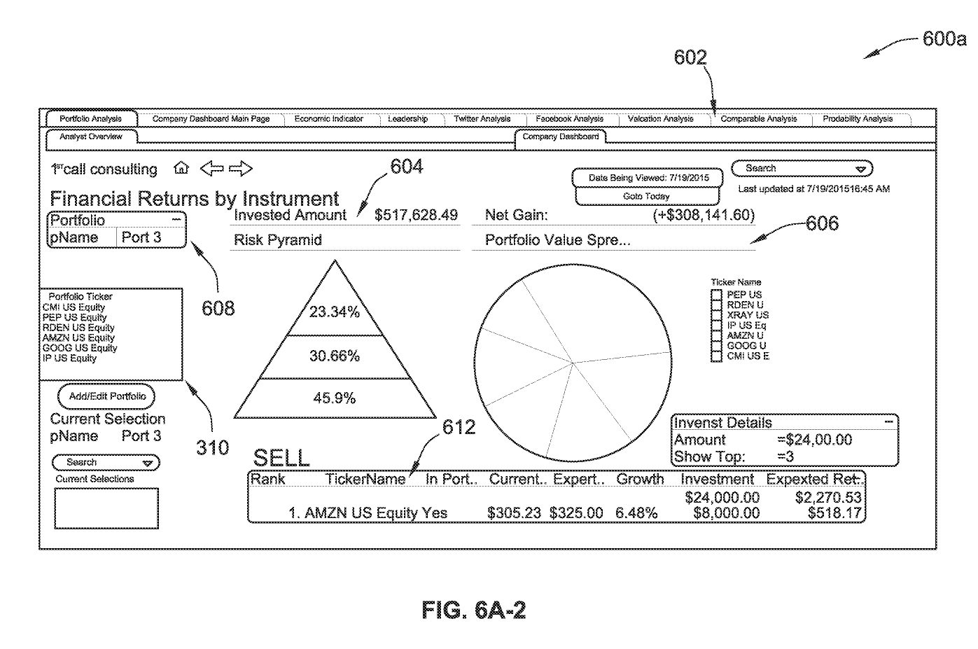

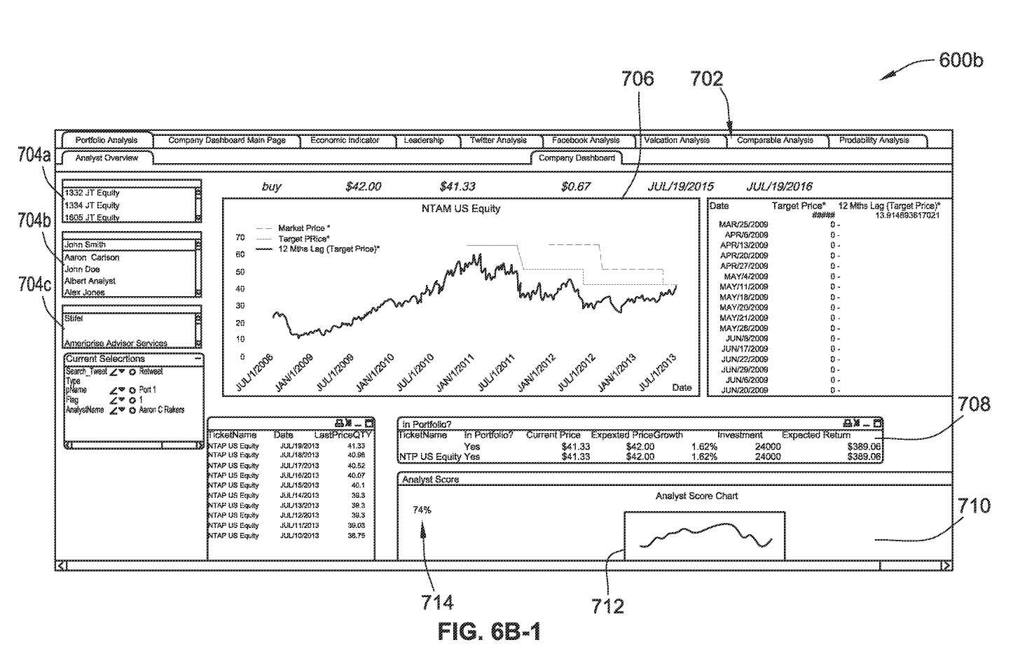

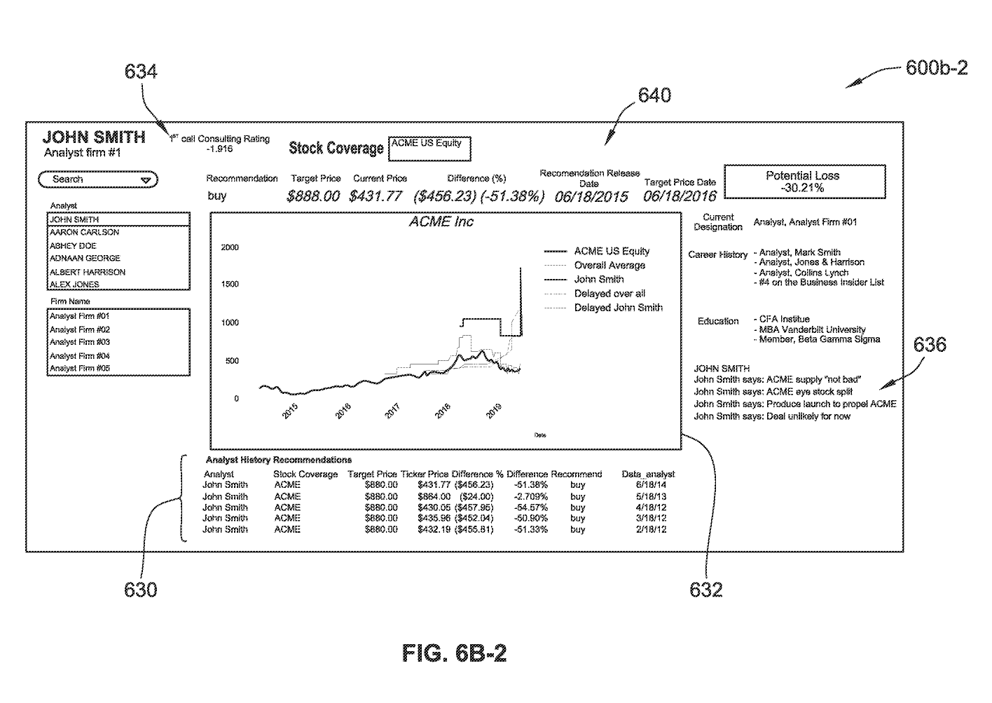

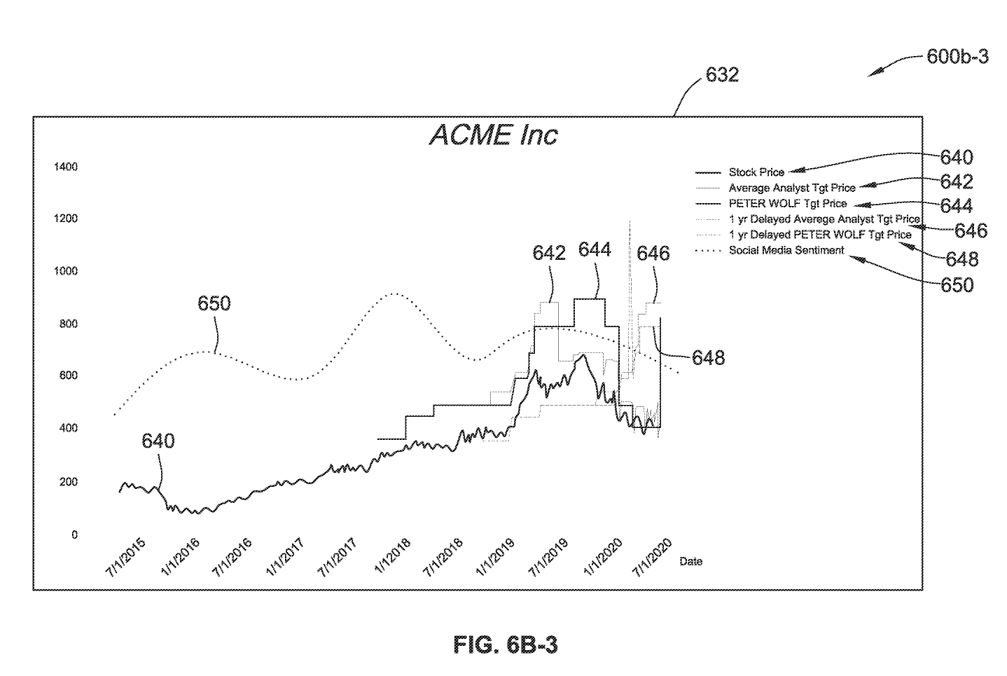

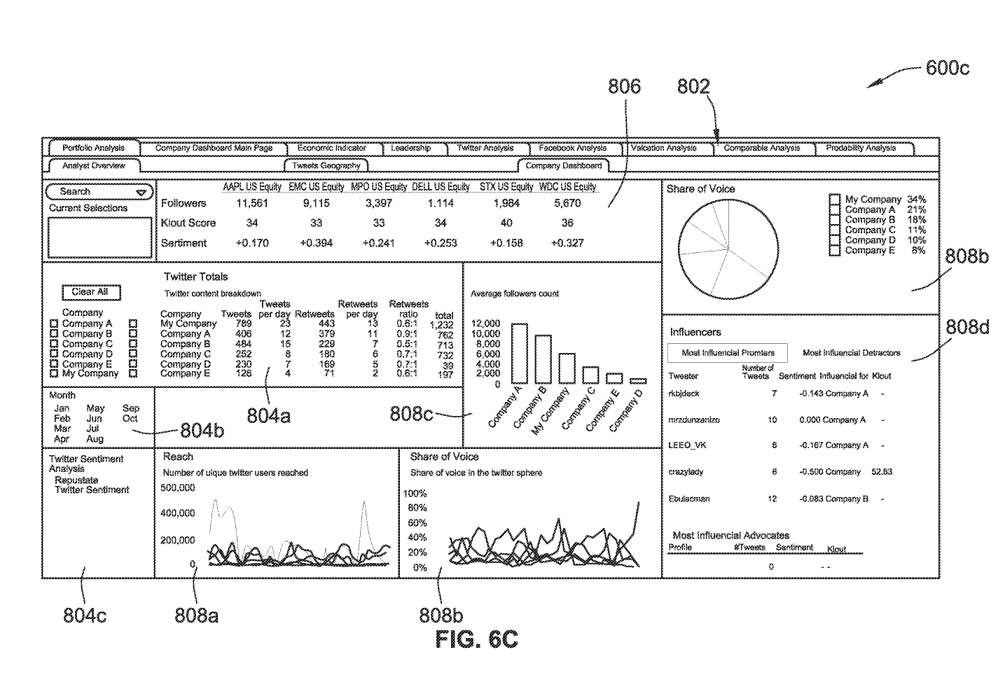

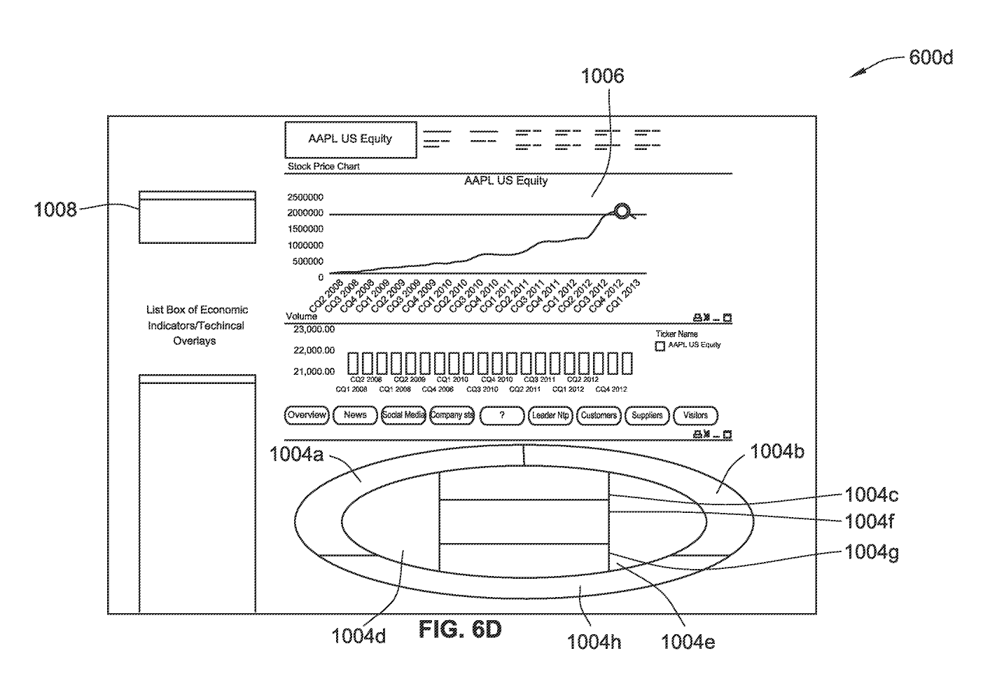

The analyst rating module 104 can also calculate the potential earnings or losses that an investor could have realized had the investor followed a particular analyst's recommendation for a selected stock. The user is shown the target price recommended by the analyst and the difference between the current stock price and the target price predicted by the analyst. For example, in FIG. 6B-2, analyst John Smith made a “buy” recommendation for ACME stock with a target price of $888 within a year of Jun. 18, 2015. The potential loss had the investor followed all of this analyst's recommendations (set forth in the table 630 showing John Smith's historical recommendations) would have been an aggregate loss of −30.21%. This information puts at the investor's fingertips an immediate dollar value to the impact of following a particular analyst's recommendations over time.

The following exemplary code samples exemplifies an implementation for calculating the potential loss shown in FIG. 6B-2:

Expressions:

Potential Earning/Loss=num(1−(FirstSortedValue(PX_LAST,Date,1)/
sum(aggr(if(Date =
Date(FirstSortedValue(Date_analyst,Date_analyst,1),‘M/DD/YYYY’),
PX_LAST,0),Date))),‘+##.##%’)
Recommendation=FirstSortedValue(Recommendation,−Date_analyst,1)
Target Price=money(FirstSortedValue([Tgt Px],−Date_analyst,1))
Current Price=money(FirstSortedValue(PX_LAST,−1*Date,1))
Difference (%)=money(FirstSortedValue(PX_LAST,−1*Date,1)−
FirstSortedValue([Tgt Px],−Date_analyst,1))
& ‘ (’
&
num((FirstSortedValue(PX_LAST,−1*Date,1)−FirstSortedValue([Tgt
Px],−Date_analyst,1))/FirstSortedValue([Tgt Px],−
Date_analyst,1),‘#.##%’)
& ‘)’

Recommendation Release

Date=date(FirstSortedValue(Date_analyst,−
Date_analyst,1),‘MM/DD/YYYY’)

Target Price Date=addmonths(date(FirstSortedValue(Date_analyst,−
Date_analyst,1),‘MM/DD/YYYY’),12);

where Tgt Px is the target price, PX_LAST is the actual price, Recommendation is the recommendation made by the analyst, such as buy, hold, or sell, Date_analyst is the date that the analysts made the target price recommendation.

An analyst rating algorithm is described next in connection with another aspect of the present disclosure. A virtual portfolio of one stock only is maintained, and the algorithm follows only one analyst's recommendation to determine whether to buy or to sell a particular stock. To rate an analyst, the following steps can be employed according to this aspect.

Assuming the algorithm starts from Zero, if the analyst recommends to Buy a particular stock, the algorithm invests a fixed amount in the stock in question and keep tracks of the transaction cost, number of shares purchased, and the actual investment amount.

Each recommendation of the analyst is stepped through chronologically, and the algorithm implements the recommendation given by him/her.

On the other hand, if a Sell recommendation for a stock is made by the analyst in question when the stock owner is in a long position for that particular stock, the algorithm goes back to ground Zero and does not short. But a subsequent Sell recommendation by the analyst will be implemented as shorting a stock for the same investment amount as before.

Similarly if a Buy recommendation is made by the analyst when the stock owner holds in a short position in the stock, the algorithm sells off the current investment in the stock, and for subsequent Buy recommendations, the algorithm invests in the stock.

The algorithm records the dollar rating of the analyst defined as the current value of the portfolio: realised and unrealised gain.

Thus, the algorithm obtains a day-by-day rating for analysts based on the variations in the unrealised gain of the stock.

Note: The amount invested is a variable and does not affect the relative ranking of analysts. It is selected to be large enough so that even the most expensive stocks can be bought in double digit number of shares.

A back testing algorithm is also disclosed, according to the following steps for handling the investments:

Step 1: The top analyst/stock pairs are chosen for a given day (e.g., 5 unique stocks, with no repetition).

Step 2: Follow the recommendation given by that analyst.

Step 3: Repeat Steps 1 and 2.

Step 4: If the portfolio has investments in more than five stocks, the algorithm realizes all the investments in stocks that are no longer being covered (i.e., not in the latest five recommendations).

Repeat Steps 1, 2, and 4 for as many times as there exists data.

The number of stocks invested in is a variable.

As will be described in more detail below, a user can use the system 100 to generate a comprehensive overview of a financial portfolio and the risk associated with the portfolio. More specifically, a user can answer, via the device 112, one or more questions regarding the financial portfolio and the user's tolerance for financial risk. The client computing device 102 communicates the user responses to the user portfolio database 128, which can interact with the equity price database 124 and the portfolio rating module 110 to generate the portfolio overview.

After the user has entered information relating to the financial portfolio and the user's tolerance for financial risk, the portfolio rating module 110 can calculate or retrieve the relative risks associated with the instruments (e.g., stocks, bonds, etc.) in the selected financial portfolio and calculate the overall risk associated with the portfolio based on these individual risks. In certain implementations, the portfolio rating module 110 can generate visual representations in which the overall risk is represented graphically in the form of a “risk pyramid” divided into low-risk, medium-risk, and high-risk tiers. The graphical element resembles a triangle or pyramid, with different levels representing increasing levels of risk. Further, the size and/or color of the tiers in the risk pyramid can vary based on the particular levels of risk associated with a user's portfolio. The portfolio rating module 110 can also generate visual data representing the makeup of the selected financial portfolio (e.g., representing percentages of a financial portfolio represented by individual instruments). Using the data generated and retrieved by the portfolio rating module 110, a visual representation of the user's portfolio can be generated and displayed on the display 114.

The following exemplary code samples exemplifies an implementation for generating a risk pyramid shown in FIG. 6A-1:

Dimension
BETA_GRP
Expression
=sum(aggr(FirstSortedValue({$<TickerName=, Flag={“1”}>}
PX_LAST,−Date,1) *
sum({$<TickerName=, Flag={“1”}>}pCount),TickerName)) /
$(=vPortTotalValue)
Color code = if([BETA_GRP] = ‘High Risk’,rgb(252,115,98)

,if(BETA_GRP = ‘Low Risk’,rgb(14,185,0)

,rgb(240,160,80)))

Legend
pCount = no. of shares
wTotalPortValue =sum({<Flag={‘1’}>} aggr(FirstSortedValue(
PX_LAST,−Date,1) *
sum(pCount),TickerName))

The system 100 can be configured to generate personalized recommendations for a user and to advise a user of one or more stocks or other financial instruments to consider buying or selling. The recommendations can be based in part on the outputs of the portfolio rating module 110, the social media analysis module 108, and the user profile data stored in the user profile database 128. The recommendations can be presented on the display 114 and be adjusted to reflect changes in market conditions, social media sentiment, and/or user preferences.

The following exemplary code samples exemplifies an implementation for calculating the average risk, average returns, and the net gain for a particular equity holding:

Average Risk
Sources
PX_LAST
pCount
RISK PREMIUM
wTotalPortValue
Algorithm
= Num(sum({<Flag = {‘1’}>} Aggr(FirstSortedValue(PX_LAST,−
Date,1) * sum(pCount)

/$(wTotalPortValue) *

avg(RISK_PREMIUM)/100,TickerName)), ‘###.##%’)
Legend
pCount = no. of shares
RISK_PREMIUM = risk of share
wTotalPortValue =sum({<Flag={‘1’}>} aggr(FirstSortedValue(
PX_LAST,−Date,1) *
sum(pCount),TickerName))
Average Returns
Sources
PX_LAST
pCount
LAST_CLOSE_TRR_1MO
wTotalPortValue
Algorithm
= Num(sum({<Flag = {‘1’}>} Aggr( FirstSortedValue(PX_LAST,−
Date,1) * sum(pCount)

/$(wTotalPortValue) *

avg(LAST_CLOSE_TRR_1MO)/100,TickerName)), ‘###.##%’)
Legend
pCount = no. of shares
LAST_CLOSE_TRR_1MO = month end returns
wTotalPortValue =sum({<Flag={‘1’}>} aggr(FirstSortedValue(
PX_LAST,−Date,1) *
sum(pCount),TickerName))
Net Gain
Sources
PX_LAST
pCount
pPrice
Algorithm
= if(Num(sum(aggr(FirstSortedValue({<Flag={‘1’}>}PX_LAST,−
Date,1) * sum({<Flag={‘1’}>} pCount)− sum({<Flag={‘1’}>}
pCount*pPrice),TickerName)), ‘$###,###.##’) > 0, ‘Gain: ’,‘Loss:
’)
(For the Color Code)
= Num(sum(aggr(FirstSortedValue({<Flag={‘1’}>}PX_LAST,−Date,1) *
sum({<Flag={‘1’}>} pCount)− sum({<Flag={‘1’}>}
pCount*pPrice),TickerName)), ‘(+$###,###.##)’)
Legend
pCount = no. of shares
pPrice = price of share

The system 100 further includes an investor preferences database 140, recommended search terms 142, a social media terms prioritization engine 144, a social media batch engine 146, a supply chain relationship database 148, a translation service module 150, a book of business module 152, and a customer relationship management module 154. The investor preferences database 140 generally stores investor data in the form of, for example, investor profiles and/or preferences received from one or more users. The profiles and/or preferences are received indirectly from the input device 112, via the analysis interface tool 116, or, optionally, directly from the input device 112. The analysis interface tool 116 retrieves the investor data from the investor preferences database 140 and communicates changes to any of the other modules and/or databases.

The analysis interface tool 116 is further communicatively coupled to a database or module with a recommended search terms engine 142. The recommended search term engine 142 is based on an algorithm with one or more inputs, including, for example, portfolio, industry interest, risk, location, time, data, investor, portfolio value, goals, etc. The recommended search terms are retrieved, for example, based on input received from a user via the input device 112 and are used to formulate specific searches. Additionally or alternatively, the recommended search terms are modified and/or updated by the analysis interface tool 116 based on additional input received from the user and/or other data received from other modules and/or databases (e.g., social media service module 118, supply chain relationship database 148, etc.). The search terms are stored by the user and/or the investor. Optionally, the search terms are stored in accordance with a location, a time, a date, and/or an instrument.

The user portfolio database 128 is communicatively coupled to the social media terms prioritization engine 144, which receives data to prioritize social media terms and/or to track the search terms. For example, the user portfolio database 128 includes data including a portfolio instruments list, a search history, a location, and a language. The data from the user portfolio database 128 is used to determine the priority for certain social media terms.

The social media batch engine 146 is coupled to the social media terms prioritization engine 144 for receiving the determined priority for the social media search terms. The social media batch engine 146 provides social media data and sentiment to the social media database 120. One advantage of the social media batch engine 146 is that the user interface is faster and all calculations are performed prior to user requests.

The analysis interface tool 116 is further communicatively coupled to the supply chain relationship database 148 to show relationships between companies. Data is stored in the supply chain relationship database 148 and includes supplier and customer relationships entered by the user via the input device 112. Chain relations related to suppliers and customers are retrieved/received from the supply chain relationship database 148 by the analysis interface tool 116 for analysis in reference to any of the other modules and/or databases of the system 100.

The social media analysis module 108 is communicatively coupled to the translation service module 150 for meeting translation requirements. For example, the translation service module 150 receives a social media original language, which is translated by the translation service module 150 and is returned to the social media analysis module 108 in the form of a user-preferred language. The translation service module 150, according to some examples, is compatible with Google and Bing search engines.

The analysis interface tool 116 is further communicatively coupled to the book of business module 152 for maintaining data related to user private investments. By way of example, a user provides input related to private investments related to real estate (e.g., condominiums), start-up venture capital investment, oil wells, etc. The private investments data is optionally analyzed in reference to any of the other modules and/or databases of the system 100. Optionally, the private investments have manually assigned risks and/or value, which can be tracked in social media.

The analysis interface tool 116 is further communicatively coupled to the customer relationship management module 154 for calendar and/or other task reminders. The customer relationship management module 154 includes links, for example, to commercial calendars such as Saleforce, Microsoft, Google, Outlook, etc. The analysis interface tool 116 determines and provides to the customer relationship management module 154 signals indicative of reminders and/or alerts. For example, the signals include reminders to call a specific contact, such as a client, and performance-related alerts on stock prices.

FIG. 2A illustrates an example flowchart of a computer-implemented algorithm 200A for analyzing a social media sentiment relating to one or more equities according to aspects of the present disclosure. The algorithm 200A begins when a portfolio list and a search term priority is received from the social media terms prioritization engine 144 (202A) Based on the portfolio list and the search term priority, the client computing device 102 generates a number of relevant search terms and/or suggested search terms related to an organization of interest and communicates these search terms to the analysis interface tool 116 (204A). In response to receiving the search terms, the analysis interface tool 116 communicates the search terms to the social media service module 118 (206A).

As described above, the social media service module 118 can be configured to interact with one or more social media databases that store social media data (e.g., postings or information about postings on social media websites or services). At block 208A, the social media service module 118 retrieves social media entries (e.g., tweets) from a social media database 120 based on the search terms. For example, in certain implementations, the social media service module 118 can retrieve tweets and/or retweets that include or refer to one or more relevant search terms or other similar search terms. The retrieved tweets can be stored locally in client computing device 102 or in a remote device on a non-transitory, tangible, computer-readable medium or media.

After the social media entries have been retrieved, the analysis interface tool 116 communicates the retrieved entries to one or more sentiment analyzers 122 (210A). After a sentiment analysis of the social media entries is performed, the analysis results for each of the analyzed social media entries (e.g., tweets, Facebook posts, etc.) are returned from the sentiment analyzers 122 back to the analysis interface tool 116. In certain implementations, the analysis results can be in the form of a numerical value or percentage reflecting whether the sentiment expressed by a given social media entry is positive, negative, or neutral.

The analysis results are transmitted to the analysis server 130, and the social media analysis module 108 calculates one or more aggregate sentiment values based on the received analysis results (212A). In certain implementations, calculating an aggregate sentiment value involves evaluating individual social media entries related to an organization of interest (e.g., a publicly traded company) and combining evaluation results for a plurality of entries to determine a composite score for the organization.

More specifically, individual social media entries can be initially scored based on an evaluation of the media source's influence (e.g., based on the source's social media presence, the source's number of social media followers, the source's geographic distance from a company of interest's headquarters or principal place of business or manufacture, etc.) For example, the initial score can be higher if the source of the social media entry has a strong social media presence (e.g., a high KLOUT score as rated by Klout, Inc.), has a large number of followers, and/or is located close to the headquarters or other important location of an organization the source has posted about. On the other hand, the initial score can be reduced if the social media source has a relatively weak social media presence (e.g., a low KLOUT score), has a small number of followers, and/or is located far from the organization the source has posted about.

The initial score for a social media entry can be modified by the results from the sentiment analysis described above with respect to block 210A to generate a modified sentiment score. The modification can involve multiplying the initial score by the sentiment analysis result, adding the two results, or combining results in a weighted manner, for example.

After the modified score is calculated for each social media entry, the group of modified scores can be organized and/or combined to generate aggregate sentiment data for an organization of interest. For example, in certain implementations, social media entries can be organized by date and the modified scores for each entry posted on a given date can be added, averaged, multiplied or otherwise combined to generate an aggregate sentiment score for that date. In other implementations, the aggregate sentiment for a given social media entry is factored by the entry's relative popularity, which can be measured, for example, by the number of times a social media user's entry was reposted by other social media users.

At optional block 214A, the analysis interface tool 116 retrieves from the social media database 120 data corresponding to one or more monitored characteristics of the user-selected organization or organizations. In certain implementations, the monitored characteristics can include data indicating the stock price of an organization at a certain time or over a time and/or date range. In certain implementations, the time/date range can be user-selected. In other implementations, the monitored characteristics can include, for example, a trading volume of an organization's stock, dividend payouts from an organization, or any other financial characteristic of an organization that a user may wish to monitor.

After the data corresponding to the one or more monitored characteristics has been retrieved and the aggregate sentiment value or values have been calculated, the client computing device 102 displays a visual representation of the sentiment data on display 114 (216A). In certain implementations, the visual representation can depict a relationship between the monitored characteristic or characteristics (e.g., a stock price, trading volume, board of trustee stock transactions, etc.) and the aggregate sentiment value or values on display 114. In other implementations, the visual representation can depict the aggregate sentiment value or values described above with respect to block 212A at a given time or over a period of time. In certain implementations, aggregate social media sentiments of a plurality of organizations can be displayed simultaneously.

The visual representation(s) can, for example, take the form of a bar graph, line graph, histogram, etc. In certain implementations, a user can interact with the visual representation by, for example, zooming in or out on the representation to display the relationship between the monitored characteristic and the aggregate sentiment over a specific date range.

FIG. 2B illustrates another example flowchart of a computer-implemented algorithm 200B for analyzing a social media sentiment relating to one or more equities according to aspects of the present disclosure. The algorithm 200B is generally similar to the algorithm 200A, except as described below. The algorithm 200B begins when a user selects at least one organization for which social media sentiment about the organization can be tracked. The client computing device 102 receives the user selection via an input mechanism, such as the input device 112 described above (202B). The user may select the organization from a predefined listing of organizations or may manually enter the organization's name or a representative ticker symbol of the organization via input device 112. Based on the user's selection, the client computing device 102 generates a number of relevant search terms related to the selected organizations and communicates these search terms to the analysis interface tool 116 (204B). In response to receiving the search terms, the analysis interface tool 116 communicates the search terms to the social media service module 118 (206B).

At block 208B, the social media service module 118 retrieves social media entries from a social media database 120 based on the search terms. After the social media entries have been retrieved, the analysis interface tool 116 communicates the retrieved entries to the social media module 118 (210B). After a sentiment analysis of the social media entries is performed, the analysis results for each of the analyzed social media entries are returned from the social media module 118 back to the analysis interface tool 116.

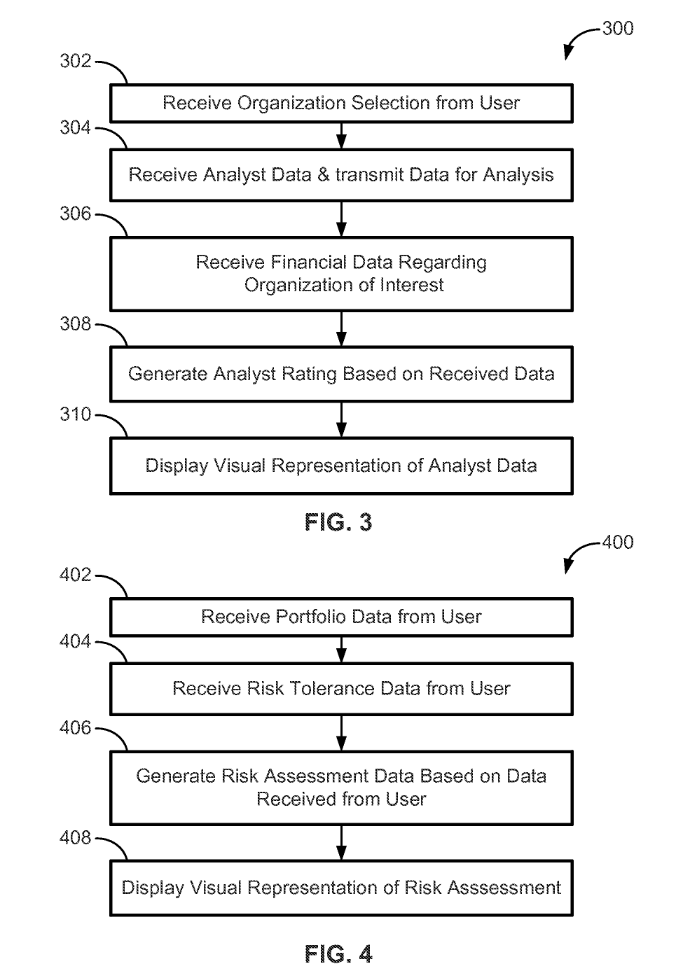

The analysis results are transmitted to the analysis server 130, and the social media analysis module 108 calculates one or more aggregate sentiment values based on the received analysis results (212B). At optional block 214B, the analysis interface tool 116 retrieves from the social media database 120 data corresponding to one or more monitored characteristics of the user-selected organization or organizations. After the data corresponding to the one or more monitored characteristics has been retrieved and the aggregate sentiment value or values have been calculated, the client computing device 102 displays a visual representation of the sentiment data on display 114 (216B). FIG. 3 illustrates an example flowchart of computer-implemented algorithm 300 for visually displaying data describing an analyst rating according to aspects of the present disclosure. In certain implementations, the analyst rating can be in the form of a numerical score or a letter grade. Other forms can be used in other implementations.

The algorithm 300 begins when a user selects at least one financial analyst to be evaluated and/or analyzed. The client computing device 102 receives the user selection via, a device interface, such as input device 112 described above (302). In certain implementations, the user can select the organization from a predefined listing of analysts or can manually enter the name of an analyst via input device 112 to see if information about that analyst is available. The client computing device 102 communicates the user's selection or entry to analysis interface tool 116.

The analysis interface tool 116 retrieves information about the selected analyst or analysts from the analyst database 126 and communicates the retrieved data to the analysis server 130 (304). The retrieved information can include, for example, the names of one or more organizations that the analyst has rated or opined upon or analyzed, the analyst's rating predictions (e.g., strong buy, buy, sell, hold) regarding the value of the organization(s), and/or recommendations or ratings the analyst has made about the organization(s). In certain implementations, the analyst database 126 can store multiple predictions an analyst has made about the future direction of a stock price of an organization (e.g., the price will rise 20 percent from its current price) and recommendations to third parties about whether they should purchase, sell, or hold shares of the organization's stock.

Along with information stored in the analyst database 126, the analysis interface tool 116 also retrieves financial data (e.g., stock price data) from the equity price database 124 for one or more organizations that the analyst has followed or analyzed (306). The equity price data can describe the price of an organization's stock over the time period that the analyst has been covering the organization and can also include data indicating the stock price of the organization for a predetermined period of time after the analyst has made a prediction about the value of the organization. For example, in certain implementations, the stock price data can include data tracking the price of a stock for a one year from the date of an analyst's comments or predictions about the stock price. In other implementations, this time period can vary.

After receiving the analyst prediction data and the relevant equity price data, the analysis server 130 automatically generates an analyst rating based on the received data (308). The analyst rating can be generated, for example, by the analyst rating module 104. In certain implementations, generating the analyst rating includes comparing an analyst's target price for a given stock (e.g., an analyst predicted that the stock price of a given company would hit $500/share) to the actual stock price over a time period (e.g., one year from the date of the analyst's prediction). The analyst rating is based on how close the price predicted by the analyst within the time period indicated came to the actual stock price during that time period.

As part of the analyst rating generation process, the analyst can be assigned a score based on the accuracy of that analyst's price prediction or predictions regarding the price or value of one or more equities. More specifically, an analyst can be assigned a maximum score (e.g., 100 points) if his prediction was completely accurate. For example, if an analyst predicted that a company's stock price would hit $500 share, and the price hit $500 within a year of the prediction, the analyst would be assigned the maximum possible score. If the analyst's prediction was not completely accurate, the analyst may still receive a positive score based on the relative accuracy of his prediction. In certain implementations, if an analyst's prediction is within a predefined percentage (e.g., 10 percent) of the actual stock price over a time period, the analyst's score may be scaled based on the accuracy. For example, if the analyst's prediction came within 20 percent of the actual stock price over a time period, the analyst may receive a score between 0 and 100 (the maximum score) based on the accuracy. In certain implementations, the analyst's score may be predefined for certain accuracy ranges (e.g., 80-85 percent accuracy corresponds to a score of “10,” 85-90 percent accuracy corresponds to a score of “20”, etc.). Conversely, if the analyst's prediction is outside the predefined percentage, the analyst may receive a score of zero or a negative score corresponding to the relative accuracy of his prediction.

The analyst can be scored according to the accuracy of the analyst's advice regarding one or more equities. More specifically, an analyst can receive a positive score if the analyst recommended to buy, hold or sell one or more equities, and that advice turned out to be accurate. For example, if an analyst advised the public to sell its shares of a particular company's stock, and the stock proceeded to lose 10 percent of its value over the coming year, analyst rating module 104 would score the analyst's advice as being accurate and would assign the analyst a positive score. Similarly, if the analyst advised the public to buy shares of a stock that rose in value or advised the public to hold shares of a stock whose price remained the same, analyst rating module 104 would again score the analyst's advice as being accurate and would assign that analyst a positive score.

On the other hand, if the analyst's advice was inaccurate (e.g., the analyst advised the public to sell the stock shortly before the stock price rose 20 percent), the analyst rating module 104 would score the analyst's advice as being inaccurate and assign that analyst a negative score or a lower score.

In certain implementations, analysts are scored based in part on their influence on the price of the equity or equities they are following. For example, if the price of a particular stock tends to increase in response to an analyst's recommendation to buy the stock or fall in response to the analyst's recommendation to sell the stock, the analyst rating module 104 can determine that the analyst has a strong influence on the price of the stock the analyst is tracking. Accordingly, the analyst rating module 104 can increase the analyst's score to reflect this influence. On the other hand, if the price of a stock does not follow or is weakly correlated with an analyst's recommendations, the analyst rating module 104 can determine that the analyst has a weak or minimal influence on the price of the stock that the analyst is following. Accordingly, the analyst rating module 104 can decrease the analyst's score to reflect this lack of influence.

If there are multiple analysts to be rated or a single analyst has rated multiple equities, the rating process described above can be repeated to account for the plurality of analyst and stock data. Additionally, in certain implementations, analysts are rated based on their analysis and predictions regarding a single equity, while in other implementations, analysts are rated based on their analysis and predictions regarding multiple equities.

In certain implementations, the analyst rating module 104 can generate a brief textual description of the analyst being evaluated. The textual description can offer a comparison of the analysts with other analysts and can also describe specific predictions the analyst has made. This textual description can offer a user additional insight into the analyst's reliability and past performance.

After the analyst rating or ratings have been generated, the client computing device 102 can display a visual representation describing the rating(s) on the display 114. If a textual description has been generated, this description can also be displayed (310). The visual representation can include the analyst rating in numerical or graphical form, along with additional information about the analyst. In certain implementations, the additional information can include data describing potential financial gains or losses if some or all of the analyst's advice had been followed over a defined period of time (e.g., the potential gains or losses over the course of a year if all of the analyst's guidance regarding buying and selling various stocks had been followed, based on an initial investment of $10,000).

FIG. 4 illustrates an example flowchart of an algorithm 400 for visually displaying data describing the status of a user's financial portfolio. The displayed data can allow the user to easily analyze the relative risk associated with his portfolio based on its content and on the user's personal risk tolerance.

The algorithm 400 begins when a user inputs data describing at least a portion of her financial portfolio. The data cam include, for example, the names of companies or other organizations that the user owns stocks, bonds, or other financial instruments in. The client computing device 102 receives the user data via, a device interface, such as the input device 112 described above (402). In certain implementations, the user can select the names of the organizations from a predefined listing of organizations or can manually enter the name of organizations manually via, for example, input device 112. The client computing device 102 communicates the user data to analysis interface tool 116.

The user is presented with one or more questions regarding her tolerance for financial risk and inputs the response(s) to the question(s) via a device interface such as input device 112 (404). The questions can, for example, ask the user about the user's short, medium, and long-term investment plans; the user's savings; the user's ability to tolerate short-term financial losses; the user's reasons for investing; and/or any other questions necessary to determine the user's investment goals and tolerance for financial risk.

After receiving user responses to the risk questions and data about the user's portfolio, the client computing device 102 transmits the received data via the analysis interface tool 116 to the analysis server 130 for further analysis, and the portfolio rating module 110 generates data representing the risk associated with the user's portfolio (406). In certain implementations, the data can be graphical data in which portfolio risk is represented by a multi-tiered triangle. For example, the portfolio rating module 110 generates graphical data that includes a triangular graphic with three tiers representing low, medium, and high-risk investments respectively.

The risk levels can be set based on the user's responses to the questions presented at block 404. For example, a user who indicated a high tolerance for risk and low concern about short-term investment losses can have a higher threshold for what is considered a “low-risk” investment than a user who indicated almost no tolerance for financial risk. More specifically, risk thresholds can be calculated based on the Beta values of the equities in a user's portfolio, where Beta represents the tendency of an equity's returns to respond to swings in the market. For example, if a stock's Beta is 1.2, then it is theoretically 20% more volatile than the market. The threshold between what are considered low-risk, medium-risk, and high-risk investments for a user with a user with a higher tolerance for financial risk may be higher than the thresholds for a user with a lower tolerance for financial risk. For example for a user, with a high tolerance for risk, a stock with a beta of 1.2 may be considered low-risk, while the same stock may be considered medium risk for a user with a low tolerance for risk.

Once a user's risk thresholds have been calculated, holdings in the user's portfolio are categorized as low, medium, and high risk, and the low, medium, and high risk proportions of a user's portfolio are calculated. For example, for a user with a high risk tolerance, the portfolio rating module 110 can determine that 25 percent of the user's portfolio by value is low risk, 35 percent of the portfolio is medium risk, and 40 percent of the portfolio is considered high risk. Of course, as described above, different users can have different risk profiles, so the same portfolio may be evaluated differently for different users. For example, a portfolio that is considered 25 percent low risk, 35 percent medium risk and 40 percent high risk for a user with a high risk tolerance can be considered 10 percent low risk, 20 percent medium risk, and 70 percent high risk for a user with a low risk tolerance.

After a user's risk thresholds have been calculated and holdings in the user's portfolio have categorized, they can be communicated to client computing device 102, which can display a visual representation depicting the rating(s) on display 114. (408) The visual representation can include the risk pyramid described above. In certain implementations, the risk pyramid is color-coded (e.g., the low-risk tier may be colored green, the medium-risk tier may be colored yellow, and the high-risk tier may be colored red). Additionally, the risk pyramid can be arranged such that the sizes of the tiers (e.g., their height) correlate with the relative risk the tiers represent. For example, if a portfolio is evenly divided between low, medium and high risk investments, each of the tiers in the Risk Pyramid may be the same size. On the other hand, if a portfolio is composed of 50 percent high risk components, 20 percent low risk components, and 30 percent medium risk components, the high risk tier may extend vertically higher and/or have a greater area than the medium risk and low risk tiers. Similarly, the medium risk tier may extend vertically higher and/or have a greater area than the low risk tier.

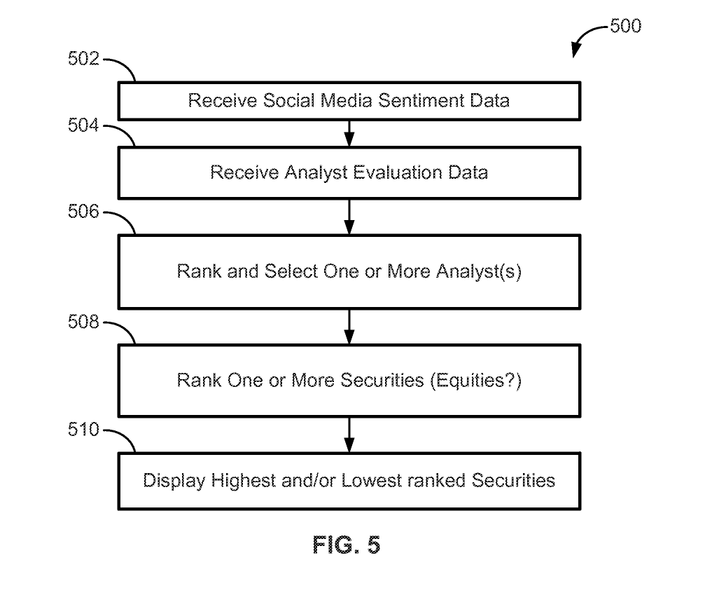

FIG. 5 illustrates an example flowchart of a computer-implemented algorithm 500 for presenting a user with a series of one or more recommendations describing equities (e.g., stocks, bonds, etc.) a user may want to buy or sell. The recommendations can be based entirely or in part on the social media sentiment regarding the particular equity or equities (described above with respect to FIG. 3) and one or more analyst ratings (described above with respect to FIG. 4). In certain implementations, the systemic risk of the equity or equities can be considered when generating the one or more recommendations.

At block 502, the portfolio recommendation module 106 receives the social media sentiment results for a plurality of equities (e.g., company stock symbols). In certain implementations, the system 100 may have previously analyzed some or all of the equities and the previously generated results may be transmitted to the portfolio recommendation module 106. In other implementations, the system 100 performs social media sentiment analysis as described above with respect to FIG. 3 in response to a request from the portfolio recommendation module 106.

The portfolio recommendation module 106 also receives the evaluation results for a plurality of financial analysts (504). As with the social media sentiment results described above with respect to block 502, in certain implementations, analyst ratings may have been previously generated by the system 100. In other implementations, the system 100 analyzes one or more analysts as described above with respect to FIG. 4 in response to a request from the portfolio recommendation module 106.

After receiving analyst evaluation results, the portfolio recommendation module 106 ranks the analysts based on their evaluations and selects one or more of the highest ranked analysts for further evaluation (506). For each of the selected analysts, the portfolio recommendation module 106 determines a risk/return parameter for one or more of the equities an analyst is following based on the analyst's ranking and the analyst's recommendations regarding the one or more equities. More specifically, the ranking of the analyst is factored (e.g., multiplied, added, other polynomial operations, etc.) by the expected return (i.e., gain or loss) of the equity or equities the analyst has evaluated. For example, a highly rated particular analyst may recommend the stock of Acme Company as a strong buy and may predict that the stock price will increase by 10 dollars per share in the next year. The ranking of the analyst may be factored with the predicted increase in stock price to determine the risk/return parameter for the stock.

After each of the equities followed by the selected analysts has been evaluated, the equities are ranked by their risk/return parameters (508). By way of example, the securities can be any instrument, such as bonds, currency, commodities, etc. In certain implementations, the rankings may include equities with both the highest expected returns and the highest expected losses. The client computing device 102 can present the highest and/or lowest ranked equities on display 114 (510). In certain implementations, a user can select how many ranked equities he would like displayed. In other implementations, the client computing device 102 presents a predetermined number of ranked equities by default (e.g., three stocks that a user should consider buying and three stocks that a user should consider selling, based on the respective risk/return parameters).

FIGS. 6A-1, 6A-2, 6B-1 to 6B-3, and 6C-6D illustrate exemplary screenshots of graphical user interfaces. These graphical user interfaces can be implemented using the system and methods described herein and allow a user to easily view consolidated financial information affecting various organizations and/or his financial portfolio. In certain implementations, the graphical user interfaces shown in 6A, 6B-1 to 6B-3, and 6C-6D can correspond to interfaces of different tabs or pages that a user can select within the same software program or suite.

FIG. 6A-1 is an exemplary screenshot of a Graphical User Interface (GUI) 600a that can be displayed on the display 114 and that presents a user with a graphical overview of an investment portfolio. Various graphical images and text entries are displayed on the GUI 600a. Navigational tabs 602 allow a user to switch between informational pages. Although the navigational tabs 602 are shown as tabs in the GUI 600a, in other implementations, other navigational interfaces (e.g., buttons, drop-down menus, etc.) can be used.

A risk pyramid 604 allows a user to visually analyze the relative risk associated with a financial portfolio, as described above with respect to FIG. 4. As described above, the risk pyramid 604 is divided into three tiers, representing low (45.9%), medium (30.66%) and high-risk (23.34%) positions in the user's portfolio. The height of each of the tiers can be commensurate with the level of risk, so that the height increases as the risk increases.

The GUI 600a also includes portfolio dropdown menu 308 and a portfolio ticker selection interface 610. In other implementations, these interface elements can be in other graphical formats but provide similar functionality. The portfolio dropdown menu 608 allows a user to select between various financial portfolios the user wishes to analyze. In certain implementations, a user can have a single financial portfolio only and the portfolio dropdown menu 608 can be omitted or can list a single portfolio only. The portfolio ticker selection interface 610 allows a user to add or remove individual entities (e.g., individual stocks) from the analysis of the selected portfolio. By adding or removing individual entities from the analysis, a user can easily see the effects that the entities have on the overall value of his portfolio and on the risk associated with the portfolio.

A portfolio value spread chart 606 presents a graphical display as a pie chart illustrating the composition of a user's portfolio. In an exemplary implementation, each entity in the portfolio is multiplied by its value (e.g., stock price) and displayed as a percentage of the entire portfolio value.

As described above with respect to FIG. 5, the system 100 can generate multiple equity transaction recommendations. A recommendation panel 612 displays a series of recommended entities that a user may consider purchasing or selling. In addition to displaying recommended entities, the recommendation panel 612 also includes relevant information about the equities such as, for example, current stock price, expected growth, expected returns based on certain investments, and whether the equity is currently in the user's portfolio. In certain implementations, a user can increase or decrease the number recommendations and/or change the investment amount expected gains or losses are based on.

FIG. 6A-2 is another exemplary screenshot of the GUI 600a in which one or more additional and/or alternative features are presented on the display 114. For example, the GUI 600a further includes a feature in which financial returns are displayed by instrument, a feature directed to an asset allocation pie chart, a feature in which a message area shows advice on recommended actions to be taken, and/or a feature with recommended sell options. FIG. 6B-1 is an exemplary screenshot of another GUI 600b that can be displayed, for example, on the display 114 of the client computing device 102. As with the GUI 600a, a number of navigational tabs are shown in the GUI 600b (element 702), allowing a user to switch between informational panels. Although tabs are shown in the GUI 600b, in other implementations, other navigational interfaces (e.g., buttons, drop-down menus, etc.) may be used. The navigational interfaces can be used to navigate to other graphical user interfaces, such as, for example, the GUI 600a described above.

The GUI 600b provides an analyst overview and includes data generated and/or calculated by the analyst rating module 104 as described above with respect to FIGS. 1 and 3. The GUI 600b includes an equity selection menu 704a, an analyst selection menu 704b, and a financial institution selection menu 704c. In other implementations, these interface elements can be in other graphical formats but provide similar functionality. The equity selection menu 604a allows a user to select between various equities (e.g., individual stocks) the user wishes to review. Based on the selected equity, the analysts and institutions listed in the analyst selection menu 704b and the financial institution selection menu 704c can change to include analysts only and/or institutions that are following (i.e., tracking or monitoring) the selected equity. The listed equities and analysts can change based on the institution selected, and the listed entities and institutions can change based on the selected analyst. For example, if a user selects analyst John Smith using the analyst selection menu 704b, the options listed in the equity selection menu 704c may change to only list equities that John Smith has evaluated and/or tracked or monitored.

A ticker display 706 graphically displays pricing data over a date range for a selected equity. The pricing data can, for example, include the actual market price of the equity, the target price for the equity as predicted by the selected analyst, and/or a time-shifted display of the target price for the equity as predicted by the selected analyst. In certain implementations, a user can change the date range to view the data over a time period of interest. The GUI 600b can also include data describing potential financial gains or losses based on the selected analyst's target price and on the current price of the equity, as shown in a table 708. The table 708 can also include data indicating whether the selected equity is already in the user's portfolio and can allow the user to adjust the described investment amount to customize expected return calculations.

The analyst scoring display 710 graphically displays one or more analyst ratings. The analyst ratings can be generated as described above with respect to FIGS. 1 and 3. In certain implementations, the analyst rating may be shown as a bar graph 712, as shown in the GUI 600b. In other implementations, the rating can be shown as a numerical value or percentage 714, as a line graph, or in any other appropriate format. In certain implementations, ratings for multiple analysts can be displayed simultaneously on the same display page, allowing a user to easily compare the analysts. Additionally and/or alternatively, the GUI 600b includes an analyst score chart. Optionally, all dates are displayed in a preferred format, e.g., in a “MM-DD-YYYY” format.

In the GUI 600b-2 shown in FIG. 6B-2, the user has selected an analyst John Smith for analysis. The company that this analyst has been tracking and making recommendations on is ACME Inc. The analyst's historical recommendations is summarized in a table 630, which shows the target price the analyst predicted, the actual price of the company (ACME), the recommendation the analyst made along with the date of the recommendation. In this manner, the user can readily see a historical snapshot of all of the recommendations made by this analyst for the company of interest. In this example, the analyst John Smith repeatedly recommended the stock for ACME at a “buy” rating, but each “buy” recommendation turned out to be incorrect. Thus, this analyst has been assigned a negative rating in the area 634 labeled “1st Call Consulting Rating” of −1.916. In an area 640, the analyst's current recommendation is shown, along with the analyst's predicted target price and the date that the stock is projected to reach that target price (here, Jun. 18, 2016). The system 100 calculates a potential loss, here of −30.21%, if the user were to follow John Smith's recommendation, and this potential loss is calculated based on the analyst rating and the accuracy of the analyst's historical predictions compared with the actual price performance of the stock being monitored.

The following exemplary code samples exemplifies an implementation for calculating the “1st Call Consulting Rating” shown in FIG. 6B-2:

1^{st} Call Consulting rating: = num(sum({$<[Actual Data vs Filled−
in Data] = {“1”},Action = {‘U’,‘D’}>}

aggr(

((sum(if(Date =

addMonths(Date_analyst,6),PX_LAST,0)) − [Tgt Px])/[Tgt Px])

+ if(((Simplified_Recommendation = 1 or

Simplified_Recommendation = 2) and (sum(if(Date =
addMonths(Date_analyst,6),PX_LAST,0)) <= [Tgt Px])) or

((Simplified_Recommendation = 4 or

Simplified_Recommendation = 5) and (sum(if(Date =
addMonths(Date_analyst,6),PX_LAST,0)) >= [Tgt Px]))

, 5
,

if(Simplified_Recommendation = 3,0,−1))

,Date_analyst,Analyst)

),‘##.###’);

This algorithm can be adjusted to reward analysts who make accurate recommendations over time. An analysts's accuracy can be rated based on the accuracy of the recommendation (e.g., a buy or a sell recommendation) and/or on an accuracy of the target price at a specified date. The target price accuracy can include an acceptable range with a penalty that increases with increased inaccuracy. This increase can be made exponential to increase exponentially the penalty as the inaccuracy increases. An exemplary scoring algorithm follows:

= if(hold, 0 ,

Else if (target period specified = true & Buy/Sell =

accurate, rec_correct(3),

Else if (target period specified = false & Buy/Sell =

accurate, rec_correct(1),

Else ( rec_wrong(−1)))))

Legend:
rec_correct = if PX_LAST at next recommendation date is higher
than PX_LAST at recommendation date, net of transaction cost
rec_wrong = if PX_LAST at next recommendation date is lower than
PX_LAST at recommendation date, net of transaction cost

An exemplary target price scoring algorithm is as follows:

= if(correct, px_correct * (1 − Δ%/ Δ%@boundary),

Else (px_wrong* (Δ%− Δ%@boundary)))

Legend:
correct = PX_LAST is within specified range of target price
px_correct = 5
px_wrong = −1

A graphical line chart 632 is also shown on the GUI 600b-2, and allows the user to see at a glance a comparison between the actual stock price performance of the organization being monitored (here ACME Inc.) against a number of analysts, including the selected analyst, John Smith. Note that this chart is merely illustrative for ease of discussion and not intended to reflect actual data. On the same chart, the actual stock price performance is shown over a date range, here a four-year window. The overall average refers to an average of a number of analysts' recommendations and target prices within a date window of interest. John Smith's target prices are also shown graphically superimposed on the same chart 632. What this exemplary chart shows immediately is that John Smith's target prices and “buy” recommendations were highly inflated and overly optimistic not only compared to the actual price performance of the stock but also his peers in the industry, whose target prices more closely tracked the actual performance of the stock price compared to John Smith's targets. This kind of information would allow the user to readily discount John Smith's recommendations, by viewing a single GUI. The user can also select recent articles or quotes by the selected analyst, John Smith, in a selection area 636, which summarizes recent quotes or statements by John Smith about the selected organization, ACME Inc. While the aggregate analyst rating provided by the system 100 is a very important data point for the user by itself, the user can also drill down into each individual analyst's historical performance to assess the credibility or efficaciousness of a selected analyst.

A GUI 600b-3 is an enlarged example chart 632 of another fictional analyst named Peter Wolf, and how Peter Wolf's target price predictions tracked the actual price performance of the fictional organization, ACME Inc. The actual price performance 640 of the stock for ACME Inc. is shown over a date range corresponding to a five-year window. The average target price 642 for a number of industry analysts is superimposed on the same chart 632. Here, it can be seen that on average the industry analysts overpredicted the price of the stock. Peter Wolf's target prices 644 is superimposed on the same chart 632, which reveals that Peter Wolf, like his peers, also repeatedly overpredicted the price of the stock. The chart 632 can also optionally show the industry average target prices delayed by a period of time 646, in this example by one year, and Peter Wolf's target prices delayed by the same period of time 648, to show how those predictions would have fared if delayed. The delay period can correspond to, for example, the actual target date for the price predicted by the analyst. The GUI 600b-3 further includes—in addition to or instead of one or more of the presently shown features—a social media sentiment line 650, which depicts the determined social media sentiment based on the analyzed social data.

The following exemplary code samples exemplifies an implementation for calculating the “1st Call Consulting Rating” shown in FIG. 6B-3:

Dimensions:
Date
Analyst
Expressions:
Stock Price:
=sum(PX_LAST)
Average Analyst Target Price:
=sum({1<TickerName={“AAPL US Equity”}>}
if(Date=Date_analyst,[Tgt Px],0))/sum({1<TickerName={“AAPL US
Equity”}>} if(Date =Date_analyst,1,0))
1−year Delayed average target price
=sum({1<TickerName={“AAPL US Equity”}>}
if(Date=addmonths(Date_analyst,12),[Tgt
Px],0))/sum({1<TickerName={“AAPL US Equity”}>} if(Date
=addmonths(Date_analyst,12),1,0))
Analyst's Target price:
=sum(if(Date=Date_analyst,[Tgt Px],0))
1−year Delayed Analyst target price:
=sum(if(Date=addmonths(Date_analyst,12),[Tgt Px],0))

In the next GUI 600c shown in FIG. 6C, the user has selected a social media overview tab. Although the GUI 600c shows a social media analysis with respect to data from the social media service known as Twitter, in other implementations, other or additional social media data sources can be analyzed. As with the GUIs 600a and 600b, a number of navigational tabs are shown in the GUI 600c (element 802), allowing a user to switch between tabs. Similarly, although tabs are shown in the GUI 600c, in other implementations, other navigational interfaces (e.g., buttons, drop-down menus, etc.) may be used. The navigational interfaces may be used to navigate to other graphical user interfaces, such as, for example, the GUIs 600a, 600b, 600b-2, 600b-3 described above.

The GUI 600c includes an organization selection menu 804a, a date selection menu 804b, and a sentiment analyzer selection menu 804c. In other implementations, these interface elements can be presented in other graphical formats but provide similar functionality. The organization selection menu 804a allows a user to select between various organizations he may want to perform social media analysis on. The date selection menu 804b allows the user to select the time period over which analysis is performed. Although the date selection menu 804b allows the user to select a month or months of interest, in other implementations, the date selection menu 804 can allow the user to choose other time periods (e.g., days, weeks, years, etc.) of interest. The sentiment analyzer selection menu 804c allows a user to select one or more sentiment analyzers 122, as described with respect to FIGS. 1A and 1B, with which to perform social media sentiment analysis of individual social media entries.

As described above, based in part on the analysis results from the selected sentiment analyzers, the social media analysis module 108 can generate an aggregate social media sentiment score for one or more organizations of interest. These sentiment scores for a plurality of organizations are shown in a table 806 (listed on the row labeled “Sentiment”). A positive number between 0 and 1 indicates a favorable sentiment, with a higher number indicating a more favorable sentiment. A negative number between −1 and 0 indicates a negative sentiment, with a lower number indicating a less favorable sentiment. A sentiment of 0 is determined to be neutral. In addition to listing aggregate social media sentiment scores, the table 806 lists other relevant social media information about the equities of interest (e.g., KLOUT Scores and the number of social media followers).

In certain implementations, the GUI 600c can include elements such as: a social media reach panel 808a, a share of voice panel(s) 808b, an average followers count 808c, and an influencers panel 808d. The social media reach panel 808a displays the number of unique users reached on a social media platform for one or more companies of interest over a period of time. The share of voice panel(s) 808b displays the relative representation of an organization on a given social media platform compared to the organizations competitors or other similar organizations over a period of time. The average followers count panel 808c displays the average number of followers an organization of interest has on a given social media platform over a period of time. The influencers panel 808d displays a listing of the most influential promoters and/or detractors of one or more organizations of interest. In other implementations, other social media metrics of interest may be displayed using other panels.

In yet other implementations, the GUI 600c can include a geography of tweets, roles of tweeters, industry of tweeters, and known analyst tweets. The roles and/or industry of tweeters can help a user gain additional insight regarding the reason for specific tweets. According to one of feature of the implementations, known analyst tweets are highlighted for ease of understanding.

In the GUI 600d shown in FIG. 6D, the user has selected a dashboard overview tab. In certain implementations, the GUI 600d can be displayed on the display 114 of the client computing device 102. As with the GUIs shown in FIGS. 6A-1 through 6C, a number of navigational tabs are shown in the GUI, allowing a user to switch between informational panels.

An organizational dashboard 1002 allows a user to easily visually analyze the relative risk factors affecting the value of an organization. In certain implementations, as shown in FIG. 6D, the risk factors can be color-coded to reflect the relative risk they each present. For example, in certain implementations, “high-risk” factors can be colored red, medium-risk factors may be colored yellow, and low-risk factors may be colored green. In other implementations, various shadings, or other representations may be used to represent different risk levels. Further, in certain implementations, more than three levels may be used to represent various risk levels. For example, in an exemplary implementation, five levels, 1-5, may be used to represent the potential risk represented by a particular risk factor, where “1” represents the lowest risk and “5” represents the highest risk.

The organizational dashboard 1002 includes panels representing risk factors potentially affecting the value of an organization. In an implementation, these panels include: a news portion 1004a, a competition portion 1004b, a leadership portion 1004c, a suppliers portion 1004d, a customers portion 1004e, a company disclosure portion 1004f, a financials portion 1004g, and a social media portion 1004h. Although the organizational dashboard 1002 is shaped as an oval in FIG. 6D, in other implementations, it can be formatted differently (e.g., as a rounded rectangle, circle, square, rectangle, trapezoid, etc.). The oval shape allows core influencers on risk to be presented in the center of the oval, with more peripheral influencers on risk to be presented toward the outer perimeter of the oval. The user's eye will be logically drawn to the center of the oval where the more critical influencers on risk are presented, such as the disclosures by the company in the company disclosure portion 1004f. The color-coding of the different risk levels helps the user to see at-a-glance the key influencers of risk potentially impacting the value of the organization of interest.

The news portion 1004a reflects the risk presented by news articles or stories about the organization of interest. For example, recent negative news about a company having to recall its top-selling product because of safety problems can be classified as high-risk. In response to this news and in the absence of other more positive news, the organization dashboard 1002 can present the news portion 1004a in a red color (indicating high risk). If the user wishes to see more detail about what prompted the risk assignment, the user can select the news portion 1004a by touching or clicking on that portion to view news articles or stories that were selected by the system 100 as reporting an event or incident that potentially impacts the value of the organization's stock price.

The competition portion 1004b reflects the risk presented by publicly available news about an organization of interest's competitors. For example, recent negative (to the organization of interest) news or disclosure about a rival company having record sales of its flagship product can be classified as medium-risk to the organization of interest. In response to this news and in the absence of other news, the organization dashboard 1002 can present the competition portion 1004b in a yellow color (indicating medium risk to the company of interest).

The leadership block 1004c reflects the risk presented by publicly available information about an organization of interest's leadership (e.g., the organization's board of trustees, CEO, CIO, etc.). For example, if a company has a new senior leader who has a history of leading successful, profitable companies, the organization dashboard 1002 can present the leadership portion 1004c in a green color (indicating a low risk to the company of interest from its leadership).

The suppliers portion 1004d reflects the risk presented by news or disclosures about an organization of interest's suppliers. For example, recent news that the primary supplier of key parts for a flagship product of a company of interest is going out of business can be classified as high-risk to the company of interest. In response to this news and in the absence of countervailing positive news, the organization dashboard 1002 can present the suppliers portion 1004d in a red color (indicating high risk to the company of interest).

The customers portion 1004e reflects the risk presented by information about an organization of interest's customers. For example, information that the unemployment rate among an organization's primary customer demographic has sharply increased can be classified as high-risk to the organization of interest. In response to this news and in the absence of countervailing positive news, the organization dashboard 1102 can present the customer portion 1004e in a red color (indicating high risk to the organization of interest).

A company disclosure portion 1004f reflects the risk presented by an organization's corporate disclosure statement. For example, if an organization has a fairly neutral and non-controversial disclosure statement, this may be classified as medium-risk to the organization of interest. In response to this news and in the absence of other positive news, the organization dashboard 1002 may color the company disclosure portion 1004f yellow (indicating medium risk to the organization of interest).

The financials portion 1004g reflects the risk presented by an organization's financial status. For example, if an organization has large cash reserves and minimal debt, this may be classified as low-risk to the organization of interest. In response to the organization's financial status, the organization dashboard 1002 can color the financial portion 1004g green (indicating low risk to the organization of interest).

A social media portion 1004h can reflect the risk presented by the social media sentiment about an organization of interest. The social media sentiment may be generated using a method similar to that described above with respect to FIG. 2A. In an exemplary implementation, if an organization has a positive reputation on social media, this may be classified as low-risk to the organization of interest. In response to this news and in the absence of other positive news, the organization dashboard 1002 can color the social media portion 1004h green (indicating low risk to the organization of interest).

In certain implementations, the GUI 600d can also include elements such as an equity price chart 1006, an equity selection menu 1008, and an equity informational panel 1010.

Although the algorithms and modules described above including those with reference to the foregoing flow charts have been described separately, it should be understood that any two or more of the algorithms or modules disclosed herein can be combined in any combination. Any of the methods, algorithms, modules, implementations, or procedures described herein can include machine-readable instructions for execution by: (a) an electronic processor device, (b) an electronic controller device, and/or (c) any other suitable electronic processing device, such as a computer, as those terms are understood by those skilled in computer arts. It will be readily understood that the system 100 can include such a suitable processing device. Any algorithm, software, module, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller device, processor device, or similar computing device (such as a computer) or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined. The use of the word “controller” or “processor” or like terms in this description or in the appended claims is not intended to invoke and explicitly does not invoke Paragraph 6 of Section 112 of Title 35 of the United States Code.

It should be noted that the algorithms illustrated and discussed herein as having various computer-implemented modules that perform particular functions and interact with one another. It should be understood that these computer-implemented modules are merely segregated based on their function for the sake of description and represent computer hardware and/or executable software code which is stored on a computer-readable medium for execution on appropriate computing hardware. The various functions of the different computer-implemented modules and computer-implemented units can be combined or segregated as hardware and/or software stored on a non-transitory computer-readable medium as above as modules in any manner, and can be used separately or in combination. Any of the components, modules, or features described can be implemented using a computer system programmed with machine-readable instructions that are stored on one or more tangible, non-transitory medium/media. The word “non-transitory” is given its meaning as of the filing date of the present disclosure to accord with wording preferences under the prevailing patent laws and judicial precedents excluding signals from eligible subject matter. Should the U.S. patent laws or judicial precedents change subsequent to the filing date of the present disclosure in such a way as to recognize non-naturally occurring signals as being eligible subject matter, aspects of the present disclosure would encompass such subject matter.

While particular implementations and applications of the present disclosure have been illustrated and described, it is to be understood that this disclosure is not limited to the precise construction and compositions disclosed herein and that various modifications, changes, and variations can be apparent from the foregoing descriptions without departing from the scope of the invention as defined in the appended claims.

What is claimed is:

1. A method for visually displaying aggregate social media sentiment data potentially impacting the value of an organization, the method comprising:
receiving, via a user interface device, a selection of an organization that is organized to purchase or sell a good or a service;
sending, via a communications interface, a plurality of search terms related to the selected organization to a sentiment analysis system;
receiving, via the communications interface, a plurality of scores from the sentiment analysis system, each of the scores being associated with corresponding ones of the search terms and being indicative of a level of positive or negative or neutral sentiment on a first set of one or more social networking services about the corresponding search term;
automatically calculating an aggregate sentiment value based on the scores, using one or more processor devices, the aggregate sentiment value being indicative of an aggregate sentiment about the corresponding search term on the first set of one or more social networking services; and
displaying, on a display device, a first visual representation that indicates a relationship between a monitored characteristic of the selected organization and the aggregate sentiment.

2. The method of claim 1, wherein the calculating the aggregate sentiment value is performed based on an average or the standard deviation of the plurality of scores.

3. The method of claim 1, wherein the first visual representation is color-coded to indicate a sentiment associated with the relationship.

4. The method of claim 1, further comprising:
receiving, via the user interface device, a user selection of a first date range; and
displaying, on the display device, a second visual representation that indicates a relationship between a monitored characteristic of the selected organization at a time or date during the first date range.

5. The method of claim 1, wherein the first set of one or more social networking services are based on a first user selection of one or more social networking services.

6. The method of claim 1, wherein the calculating the aggregate sentiment value comprises factoring the influence of at least one of the one or more social networking services on the monitored characteristic of the selected organization.

7. A method of visually displaying aggregate analyst data regarding the potential value of an organization, the method comprising:
receiving, via a communications interface, a plurality of analyst data, the analyst data comprising data indicative of a first analyst's opinions regarding the value of a first set of one or more organizations;
automatically generating, using one or more processor devices, a first analyst rating based on the plurality of analyst data, the first analyst rating being indicative of a comparison of the first analyst's opinions regarding a predicted value of a characteristic of one or more organizations with respect to an actual value of the characteristic of one or more organizations at a designated time; and
displaying, on a display device, a visual representation of the first analyst rating.

8. The method of claim 7, wherein the calculating the first analyst rating comprises:
comparing the predicted value of the characteristic with a threshold value range;
increasing a rating value when the predicted value is within the threshold value; and
decreasing the rating value when the predicted value is outside the threshold value range.

9. The method of claim 8, wherein the increasing the rating value comprises increasing the rating value by an amount proportional to an accuracy of the first analyst rating.

10. The method of claim 8, wherein the decreasing the rating value comprises decreasing the rating value by an amount proportional to an accuracy of the first analyst rating.

11. The method of claim 7, further comprising: displaying, on the display device, a selectable listing of a plurality of analysts, the plurality of analysts including one or more analysts distinct from the first analyst.

12. The method of claim 7, further comprising: displaying, on the display device, a selectable listing of a plurality of organizations, the plurality of organizations including one or more organizations distinct from the organizations in the first set of one or more organizations.

13. The method of claim 7, wherein the analyst rating reflects the analyst's experience.

14. The method of claim 7, further comprising:
automatically calculating a potential earning measurement reflecting potential earnings based on the first analyst's opinions regarding the predicted value of the characteristic of one or more organizations; and
displaying, on the display device, a visual representation of the potential earning measurement.

15. The method of claim 7, further comprising:
receiving, via the communications interface, an aggregate sentiment value potentially impacting the value of an organization;
automatically calculating an action suggestion indicator value based on the aggregate sentiment value and the first analyst rating; and
displaying, on the display device, a first visual representation of the action suggestion indicator value that indicates a suggestion regarding a monitored characteristic of at least one of the one or more organizations.

16. The method of claim 15, wherein the automatically calculating the action suggestion indicator value further comprises analyzing a systemic risk of the at least one of the one or more organizations.

17. A method for visually displaying an aggregate representation of a user's portfolio, the portfolio including one or more instruments associated with one or more organizations organized to purchase or sell a good or a service, the method comprising:
receiving, via a user interface device, an indication of the one or more instruments;
receiving, via a user interface device, one or more user responses indicating the user's risk tolerance with respect to the user's portfolio;
automatically calculating an aggregate assessment based on the indication and the one or more user responses, the aggregate assessment being indicative of an evaluation of a risk offered by the user's portfolio and how the risk correlates with the user's risk tolerance;
displaying, on a display device, a first visual representation that reflects the aggregate assessment in a graphical format.

18. The method of claim 17, wherein the first visual representation represents the aggregate assessment in a multi-tiered triangular graphic.

19. The method of claim 18, wherein each of a plurality of tiers in the graphic represents a risk level associated with a portion of the user's portfolio.

20. The method of claim 19, wherein a size of each of the plurality of tiers is correlated to the risk level associated with each of the plurality of tiers.

21. The method of claim 17, further comprising displaying, on the display device, a second visual representation alongside the first visual representation, the second visual representation reflecting a diversity of the user's portfolio.

22. The method of claim 21, further comprising:
displaying, on the display device, a second visual representation alongside the first visual representation, the second visual representation reflecting a risk tolerance selection mechanism, wherein a user may interact with the second visual representation to select an updated risk tolerance; and
automatically updating the aggregate assessment based on the updated risk tolerance.
